(19) United States
(12) Patent Application Publication
(10) Pub. No.: US 2005/0179844 A1
(43) Pub. Date: Aug. 18, 2005

(54) Bistable liquid crystal device with picture electrodes having comb structure

(76) Inventors: Sander Jurgen Roosendaal, Eindhoven (NL); Mark Thomas Johnson, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/513,875

(22) PCT Filed: Apr. 17, 2003
(86) PCT No.: PCT/IB03/01541

(30) Foreign Application Priority Data
May 10, 2002 (EP) 02076850.3

(51) Int. Cl. G02F 1/1343

(52) U.S. Cl. 349/139

(57) ABSTRACT

By giving the picture electrodes (15) in liquid crystal displays based on bistable nematic effects a comb structure with varying distance between teeth (23) of the comb, or a comb structure having a varying width of at least one tooth of the comb, more stable gray levels are obtained.

The invention relates to a liquid crystal display device comprising between a first substrate and a second substrate a nematic liquid crystal material, at least one substrate being provided with electrodes, which define picture elements (pixels), the device comprising driving means for driving the picture elements in a range between two stable states, liquid crystal molecules in the stable states having different twist angles viewed from one substrate to another.

Liquid crystal display effects, based on bistability of a nematic liquid crystal material, are well known. One example is the supertwist nematic effect, showing two stable states, which is used in many display applications, ranging from mobile phones to laptop computers. Other bistable electro-optical effects have been described for instance by Dozov et al. (“Recent Improvements of Bistable nematic Displays Switched by Anchoring Breaking”, SID 2001, pages 224-7).

Bistable liquid crystal displays have very low power consumption if the update frequencies are low. This makes them very suitable for applications in mobile devices like electronic books. However in these applications a growing need exists for the possibility to show images having color, gray-scales and video content.

The bistable electro-optical effects in general have little possibility to fulfill these needs. Realizing of gray-scales for so-called π bistable twisted nematic liquid crystal displays is described by Xie et al. (Bistable Twisted Nematic Liquid Crystal Displays with Permanent Grayscales and Fast Switching), SID 01 Digest, page 228-231, 2001 in which the electrodes having a comb structure comprising teeth. During switching voltages are applied, such that a high electric field exists between a further (pixel) electrode and the comb electrode. This leads to fringe fields at the edges of the teeth of the comb where the field lines are not perpendicular to the planes of the electrodes. The fringe fields cause breaking of the anchoring of the liquid crystal at the comb electrode, and depending on the voltage, a high twist or a low twist state may be achieved.

Although Xie et al. have shown that it is possible to obtain gray scales by driving at intermediate voltages, obtaining a reproducible gray scale remains a problem. Near the edges of the comb electrodes, the anchoring breaks and part of the pixel will switch to the other stable state, while another part will remain in the original state. With this kind of driving, it is difficult to obtain reproducible gray scales, especially when driving from one gray level to the other.

It is one of the objects of the invention to overcome these objections by providing a bistable liquid crystal display device having a reproducible gray scale.

To this end in a liquid crystal display device according to the invention the electrodes at least partly have a comb structure with varying distance between teeth of the comb or a comb structure having a varying width of at least one tooth of the comb.

With “at least partly having a comb structure” it is meant that the ends of the teeth of such a comb structure may be interconnected again, e.g. via a common electrode strip.

The invention is based on the insight that the relative size of the black and white domains in the picture element (pixel), instead of being dependent on nucleation and growth only, now mainly is controlled by the layout of the comb. A different threshold voltage for complete switching occurs in different parts of the pixel. At certain addressing voltages, some parts of the picture element (pixel) will switch, while others will not.

The varying distance between teeth of the comb may be obtained on the one hand by different interteeth distance between two neighboring teeth of the comb.

On the other hand opposing sides of two teeth may have staircase-like edges.

Preferably opposing sides of two neighboring teeth are provided with nucleation centers (e.g. tapered structures).

More generally the invention is based on the insight that the relative size of the black and white domains in the picture element (pixel) mainly is controlled by a (controlled) variation of the electrical field distribution, which also can be obtained by electrodes which at least partly have a structure with openings the forms or the areas of the openings varying over the area of an electrode.

These and other aspects of the invention will be apparent from and elucidated with reference to the embodiments described hereinafter.

In the drawings:

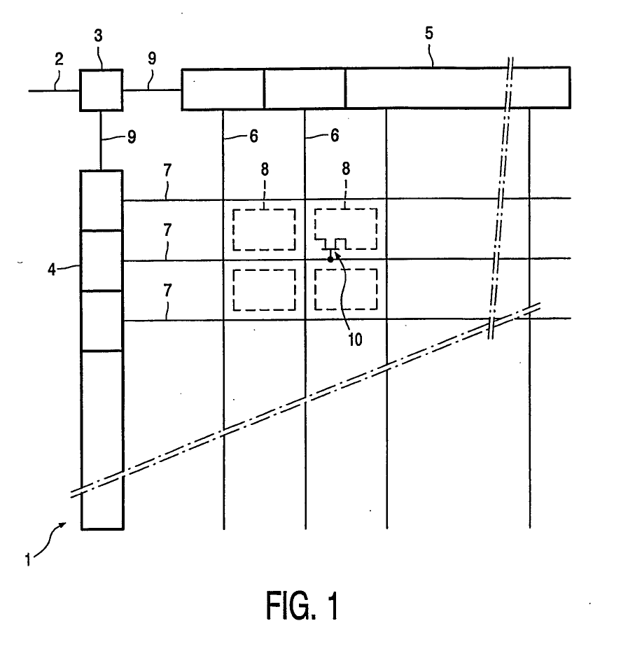

FIG. 1 is an electric circuit diagram of the display device,

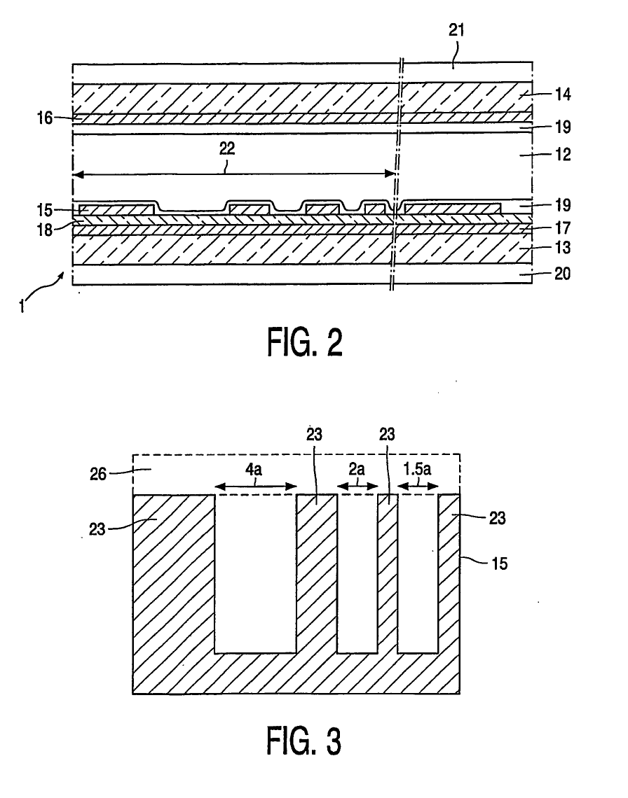

FIG. 2 is a cross-section of a display cell of a device according to the invention, while

FIGS. 3, 4, 5, 6 and 7 are plan views of picture electrodes in a display cell of a device according to the invention and

FIG. 8 shows a plan view of another picture electrode in a display cell of a device according to the invention.

The Figures are diagrammatic and not drawn to scale; corresponding parts are generally denoted by the same reference numerals.

FIG. 1 is an electric equivalent circuit diagram of a part of a display device 1 to which the invention is applicable. It comprises in one possible embodiment (one mode of driving, called the “passive mode”) a matrix of pixels 8 defined by the areas of crossings of row or selection electrodes 7 and column or data electrodes 6. The row electrodes are consecutively selected by means of a row driver 4, while the column electrodes are provided with data via a data register 5. To this end, incoming data 2 are first processed, if necessary, in a processor 3. Mutual synchronization between the row driver 4 and the data register 5 takes place via drive lines 9.

In another possible embodiment (another mode of driving, called the “active mode”) signals from the row driver 4 select the picture electrodes via thin-film transistors (TFTs) 10 whose gate electrodes are electrically connected to the row electrodes 7 and the source electrodes are electrically connected to the column electrodes. The signal which is present at the column electrode 6 is transferred via the TFT to a picture electrode of a pixel 8 coupled to the drain electrode. The other picture electrodes are connected to, for example, one (or more) common counter electrode(s). In FIG. 1 only one thin-film transistor (TFT) 10 has been drawn, simply as an example.

FIG. 2 is a cross-section of a part of a liquid crystal material 12 which is present between two substrates 13, 14 of, for example, glass or (flexible) synthetic material, provided with (ITO or metal) picture electrodes 15 and a counter electrode 19 respectively. As described by Xie et al. (Bistable Twisted Nematic Liquid Crystal Displays with Permanent Grayscales and Fast Switching, SBD 01 Digest, page 228-231, 2001), the bistable device further comprises a further plane electrode 17, which is electrically isolated from the picture electrodes 15 by a dielectric layer 18. The device further comprises alignment layers 19, 19′ and polarizers 20, 21. The size of one picture element (pixel) is denoted in FIG. 2 by double arrow 22.

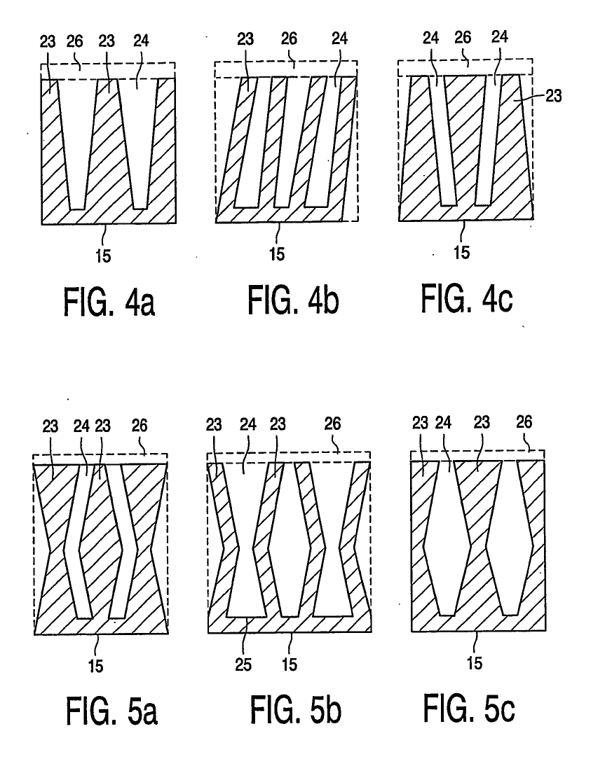

According to the invention the electrodes 15 have a comb structure with varying distance between teeth of the comb. As shown in FIG. 3 the distance between two neighboring teeth 23 is 4a, 2a and 1.5a respectively. In this way, different threshold voltages for complete switching exist in different parts of the pixel. At certain addressing voltages, some parts of the pixel will switch, while others will not. In this way, the relative size of the black and white domains in the pixel is controlled by the layout of the comb electrode, instead of being dependent on nucleation and growth of the domains, as in Xie et al. This also applies to a comb structure having a varying width of the teeth 23 of the comb, as shown in FIG. 4(a), 4(c) or a structure in which the distance 24 between two neighboring teeth is varying, while the width of the teeth 23 is substantially constant as shown in FIG. 4(b).

In the embodiments as shown in FIG. 5, the black and white domains appeared to be spread more evenly over the pixel.

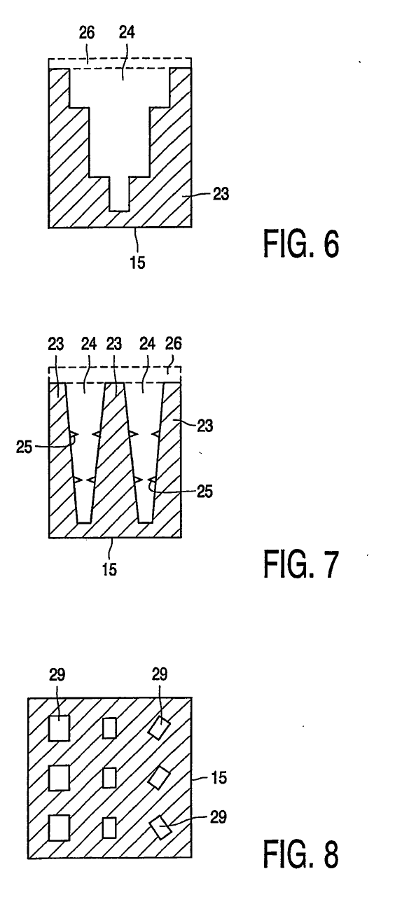

Discrete steps in the grayscale (and a high reproducibility) are obtained by introducing a kind of barrier at well-defined points for the growing of the nucleation process. One way to achieve this is to introduce step functions as shown in the embodiment of FIG. 6, Of course, increasing the number of steps increases the number of gray levels. An alternative solution is shown in FIG. 7 in which a similar comb electrode as shown in FIG. 4 is used, but small structures (in this example tapered structures) are added to stop the nucleation of the stable state at well-defined points.

The protective scope of the invention is not limited to the embodiments described. As mentioned in the introduction the teeth 24 may be interconnected via a further electrode strip 26, shown by means of dashed lines in FIGS. 3 to 7.

In FIG. 8 the relative size of the black and white domains in the picture element (pixel) variation of the electrical field distribution, controlling the relative size of the black and white domains in the picture element (pixel) obtained by an electrode which has a structure with openings 29. By varying the forms or the areas of the openings over the area of an electrode a similar beneficial effect (more stable gray levels) may be obtained in other bistable display effects.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A liquid crystal display device comprising between a first substrate and a second substrate a nematic liquid crystal material, at least one substrate being provided with electrodes, which define picture elements, the device comprising driving means for driving the picture elements in a range between two stable states, liquid crystal molecules in the stable states having different twist angles viewed from one substrate to another, the electrodes at least partly having a comb structure with varying distance between teeth of the comb or a comb structure having a varying width of at least one tooth of the comb.

2. A liquid crystal display device as claimed in claim 1 in which opposing sides of two teeth have staircase-like edges.

3. A liquid crystal display device as claimed in claim 1 in which the interteeth distance differs between two neighboring teeth of the comb.

4. A liquid crystal display device as claimed in claim 1 in which nucleation centers are provided along edges of the electrodes.

5. A liquid crystal display device as claimed in claim 4 in which opposing sides of two neighboring teeth are provided with nucleation centers.

6. A liquid crystal display device as claimed in claim 5 in which opposing sides of two teeth are provided with tapered structures.

7. A liquid crystal display device comprising between a first substrate and a second substrate a nematic liquid crystal material, at least one substrate being provided with electrodes, which define picture elements, the device comprising driving means for driving the picture elements in a range between two stable states, liquid crystal molecules in the stable states having different twist angles viewed from one substrate to another, the electrodes at least partly having a structure with openings the forms or the areas of the openings varying over the area of an electrode.

8. A liquid crystal display device as claimed in claim 1 in which nucleation centers are provided along edges of the electrodes or within the openings in the electrodes

9. A liquid crystal display device as claimed in claim 1 comprising on the first substrate a switching element between a driving electrode and a picture electrode.

10. A liquid crystal display device as claimed in claim 9 comprising row electrodes and column electrodes on the first substrate, the switching element being a thin film transistor.
